(19) United States
(12) Patent Application Publication
(10) Pub. No.: US 2010/0100607 A1
(43) Pub. Date: Apr. 22, 2010

(54) Adjusting Content To User Profiles

(76) Inventors: Martin B. SCHOLZ, San Francisco, CA (US); Somnath Banerjee, Bangalore (IN); Rajan Lukose, Oakland, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/256,340

(22) Filed: Oct. 22, 2008

(51) Int. Cl. G06F 15/16

(52) U.S. Cl. 709/219

(57) ABSTRACT

One embodiment is a method that determines at a client computer a relevancy of information received with respect to a user profile. The method then adjusts a ranking of the information according to the relevancy and displays a selected portion of the adjusted information on the client computer.

### BACKGROUND

Web-based communities and hosting services aim to facilitate sharing of information to users. Web 2.0 offers various mechanisms for end users to subscribe to news and other dynamic content, for instance RSS feeds. Many users cannot manually filter the quickly changing data received from all the potentially relevant sources. For one reason, too much information exists to adequately filter. Information overflow due to a lack of personalization (low relevance) has recently emerged as a problem on both news portals and specific client-side reader software.

The problem of information overflow cannot be easily solved even if users formulate precise querying and information filtering criteria. Other obstacles still exist. In the news domain for instance, information depends on events in the outside world and users are not trained to specify their interests in an appropriate formal way. Further, relevance of information often varies systematically over time. Even over short periods of time, relevant information changes as to different personal contexts a user encounters.

### BRIEF DESCRIPTION OF THE DRAWINGS

FIG. 1 is a flow diagram for adjusting web content with user profiles in accordance with an exemplary embodiment.

FIG. 2A is a block diagram of web content before being adjusted with a user profile in accordance with an exemplary embodiment.

FIG. 2B is a block diagram of web content after being adjusted with a user profile in accordance with an exemplary embodiment.

FIG. 3 is a block diagram of a computer for executing methods in accordance with an exemplary embodiment.

### DETAILED DESCRIPTION

Exemplary embodiments are directed to apparatus, systems, and methods to adjust web content based on a user profile. In one embodiment, behavior of a user on a client computer is monitored and used to build a profile of the user. Thereafter, web pages, electronic documents, or modules having a specific function (for example, RSS feeds) are altered or changed according to relevancy of their content with respect to the user profile.

In one embodiment, the profile of the user is built on the client computer, not on a central or shared server. Further, assessment of incoming web content is compared with the user profile and ranked at the client computer. Performing these functions on the client computer, as opposed to a shared server, protects the personal information of the user from being disseminated, reviewed by unauthorized third parties, misappropriated, and subjected to other privacy concerns.

Incoming information or web content is automatically changed based on the user profile. For example, as an RSS feed retrieves headline news information, the content 6f the news is compared and ranked with respect to the user profile. Textual similarities between the headline news stories and the user profile are determined, and these similarities are used to change how the headline news stories are presented to a user on a personalized web page of the user. For instance, new stories having a higher relevancy to the user profile are moved up or to the top of a module on the web page. By contrast, news stories having a lower relevancy to the user profile are moved lower or even removed from being displayed in the module. In this manner, the more relevant headline news stories are presented first or given a higher hierarchical listing on the web page of the user.

In one exemplary embodiment, a system residing on a local computer monitors behavior of the user. By way of example, the system monitors all recently visited web pages, blogs, and RSS feed items to determine current interests and information needs of the user. This information is used to build the user profile on the client computer. The same system then uses this detailed user profile to rank potentially relevant content fetched from the internet according to the estimated likeliness of relevance to the user profile.

Exemplary embodiments offer a personalized news and content platform to end users that offer a convenient access to the information that is most relevant to the user. Exemplary embodiments also automatically adapt to personal preferences and interests without any need for the user to set up a profile manually or enter search terms. Maintaining the profile and ranking on the local computer ensures privacy without disclosing any personal information of the user to third parties.

One embodiment uses a personalization engine that executes on the client computer. The engine monitors relevant actions of a user and compiles them into the user profile that is used for subsequent content recommendation. The term “recommendation” subsumes both the selection (or filtering) and ranking of articles. No details of user profiles have to leave the local machine (client computer).

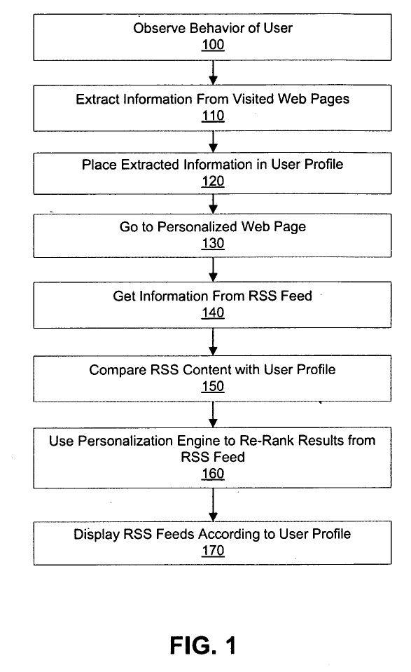

FIG. 1 is a flow diagram for adjusting web content with user profiles in accordance with an exemplary embodiment. According to block 100, the behavior of the user is observed. For example, user activity with respect to web pages is observed.

According to block 110, information is extracted from the web pages visited by the user. Real-time information is collected and stored while the user navigates to different web pages. The content or actual information presented on the web pages is used to build the user or client profile.

A system that monitors a user on a personal computer has access to all the personal information stored on that machine. In one embodiment, a major source of information to be used for assembling a profile on the personal computer of the user is the behavior of the user on the web page being visited. To this end, specific web browser plug-ins installed on the client computer constantly collect relevant information, in particular the HTML content of all pages visited by a user. Depending on the computational resources that are available for the application, the browsing history of the user can then be analyzed using a technique of appropriate complexity. A transformation of visited pages into a BOW (bags of words) representation is computationally quick and can be operationalized as a service (process) that is constantly running in the background. This background process transforms and stores each web page at the same time the web browser displays it to the user.

A more complex way to extract information for specific tasks is Named-Entity Recognition. This technique allows information to be discovered in web pages. For instance, the technique can find persons, city names, companies, and other entities in web pages. Such features allow embodiments to construct meaningful components in bag of words representations.

According to block 120, information extracted from web pages is placed in a profile. This information is used to build the user profile.

In one exemplary embodiment, based on any BOW representation of a user's web history, different methods exist to compute a user profile. Rather than using raw BOW vectors, one exemplary format is an IR (information retrieval) technique which is a term frequency-inverse document frequency (TFIDF) representation. The cosine of corresponding vectors in this representation is used as a similarity measure for text documents.

Other exemplary embodiments support more complex features to be incorporated into the vectors, such as semantic annotations, meta-data, or named entities, and any better suited similarity measure between documents. The following strategies allow exemplary embodiments to rank candidate documents based on the computation of a personal profile.

In one embodiment, an efficient way to compute a profile from the web history TFIDF is to collapse this matrix to a single vector by computing the average TFIDF vector of all documents as their arithmetic mean. In this representation, many terms resembling specific user interests can be expected to occur more frequently than for the average user. The similarity of the candidate documents to this profile vector is used as an efficient strategy for ranking the documents.

Another embodiment does not collapse the matrix to a single vector, but ranks the candidate documents by their similarities to any page visited by the user (nearest neighbor). This strategy gives higher weight to the occurrence of rare specific terminology in both the candidate page as well as the web history.

As another example, content from different sources will usually be semantically “typed.” For example, interest in “World news—Iraq” does not necessarily imply interest in “Travel deals—Iraq”. Depending on the degree of structure and other characteristics the following three solutions allow an exemplary embodiment to use only the relevant part of the web history to score each specific candidate document.

As a first solution, if the content to be selected and ranked is classified or annotated appropriately, then the parts of the web history that are useful to build a profile for selecting and ranking the corresponding content are usually a subset of the full web history. Classifiers built offline and uploaded to the client are used to select these relevant web pages. This helps to build a separate category specific profile based on the relevant content only.

As a second solution, even without any given taxonomy unsupervised machine learning techniques like clustering or (probabilistic), latent semantic indexing allows an exemplary embodiment to form groups of similar, and hence usually related candidate documents. These documents can then be annotated by the group(s) to which they belong. By way of example, each group is characterized referring to terms that are more frequently observed than in all other groups or on average. These characterizations are then used as classifiers to find the relevant parts of the web history to build a profile.

As a third solution, a similar approach is taken to classify web pages with respect to the different available sources. Lazy learning schemes like k-nearest neighbors allow an exemplary embodiment to classify the set of pages from the web history in terms of the different sources of candidate content. For each history page, the k most similar content pages are retrieved. Based on the cumulated similarity scores and neighbors per source, each page is classified as relevant to none, one, or multiple sources. Again, for each source a separate profile is built from the relevant pages, and it is used to select and rank candidate pages from that source by similarity to the profile.

As another example, timeliness of content that is presented to a user is utilized. The profile of a user can change over time. So recently visited pages in the web history generally receive a higher weight than older pages. To account for these properties of the application, a timestamp of web pages is used to compute a decay factor that changes the time-agnostic similarity scores. The decay factor of each document or visited web page is a function of the time a page was visited or an article was published and the current time. A straightforward choice is to define a time after which the impact of a page halves, leading to an exponential decay. More complex schemes can be incorporated by considering more complex functions above. By way of example, such schemas include accounting for the fact that behavior on weekends is different from weekdays, and that the time of day can have a high impact as well.

As yet another example, profiles for reoccurring topics or activities on the web are improved by retrieving only the set of related pages from the history. An appropriate similarity measure allows an exemplary embodiment to introduce weights to the pages in the history that resemble their relevance to the current topic or activity. The resulting short-term profiles help to quickly switch between different contexts. Exemplary context include “working” and “shopping.”

As yet another example, any page a user visits can contain further useful information, such as further RSS feeds that contain relevant information. When enough evidence for the usefulness of a new data source has been collected, the user is prompted on whether or not this feed should be added to the list of monitored sources.

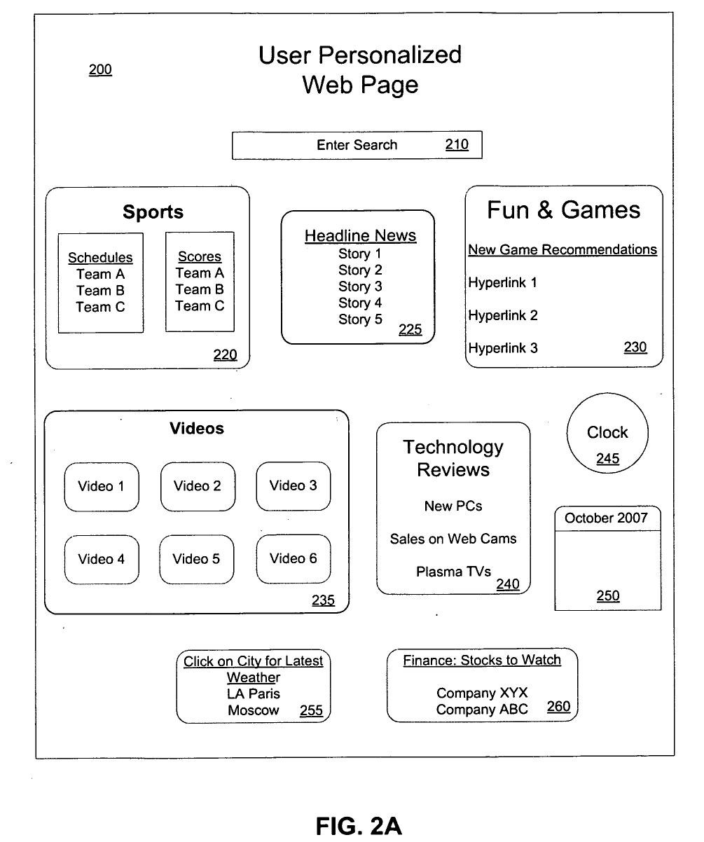

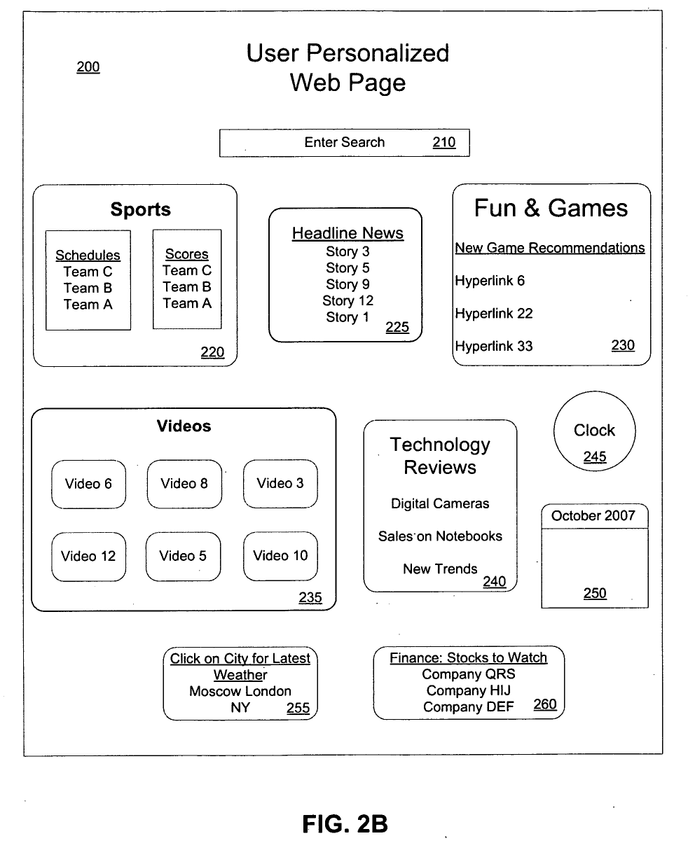

According to block 130, a user navigates to a personalized web page. FIG. 2A is a block diagram of web content of a personalized web page 200 before being adjusted with a user profile in accordance with an exemplary embodiment.

The personalized web page 200 includes a query box 210 and a plurality of modules 220-260. By way of example, these modules include, but are not limited to, a sports module 220, a headline news module 225, a fun and games module 230, a video module 235, a technology reviews module 240, a clock module 245, a calendar module 250, a weather module 255, and a finance module 260. The number, type, size, format, and content of these modules are provided for illustration. One skilled in art appreciates that personalized web pages vary with each user and exemplary embodiments include the wide variety of such variations.

The modules provide automatic and real-time updates for information content directed to the particular topic chosen by the user. For example, the RSS headline news module 225 receives syndicated audio files, images, text, and hyperlinks for headline news stories. Such media modules can include other types of content and information, such as film, video, TV, as well as provide additional metadata with the media. Media RSS enables content publishers and bloggers to syndicate multimedia content such as TV and video clips, movies, images, audio, etc.

By way of illustration, this module 225 includes five news stories (labeled Story 1 to Story 5). These stories are periodically or automatically updated according to rules of the information provider and are listed in a predetermined hierarchy. The stories are not listed or presented in a manner that is relevant to a particular user or a particular client computer. In other words, information in the modules is not presented with relevance to the user profile. Instead, popular or most current news stories are listed at the top (i.e., Story 1) while older or less popular news stories are listed farther down the list (i.e., Story 5, Story 6, . . . Story N). Generally, as stories become older in time, they simultaneously become less relevant and hence are moved farther down the list. The specific order of information in the modules is determined by the web portal, web designer, host, or the like.

The web page 200 is personalized since the user selects which and where modules are presented on the page. Typically, a user selects from one or more different modules provided by the web page designer. By way of example, a user could select from different topics, such as news, sports, finance, weather, entertainment, travel, fashion, health, etc. This list is not intended to be exhaustive but rather illustrative of choices for topics in a personalized web page.

According to block 140 in FIG. 1, information is obtained from one or more content providers or information sources, such as an RSS feed. By way of example, a content recommender service runs as an application on a client computer with Internet access. The service prefetches potentially relevant information from web pages, RSS feeds, and blogs, and can be extended for other kinds of dynamic web content.

In one exemplary embodiment, most of the fetched content is in textual form, or a textual description if available. The first step is to convert the content into a format that allows for efficient recommendations in real-time. Examples of such techniques include techniques in fields like information retrieval (IR) and text mining that represent textual documents as bags of words (BOW).

To be able to build upon this retrieval technique, content is parsed. HTML tags, scripts, and other irrelevant parts of HTML pages are removed. Further, the title and description of individual RSS feed items are extracted and assembled into a plain text document. A standard IR procedure is to tokenize the resulting plain text, remove stop words, use a stemming algorithm, and finally represent each HTML page as a term vector. Efficient retrieval of contents given a specific profile or query can, for example, be achieved by using a full-text indexer.

In one embodiment, a more meaningful representation of the content is achieved by classifying each item in terms of conceptual knowledge. Depending on the kind of content, this can result in a single class per document or in a set of semantic tags per document that reflect the content. If the content source does not provide sufficient information, there is a natural way of annotating documents, which is to build a set of classifiers offline from a classified reference corpus. This strategy applies to multi-class classification problems as well as to assigning a fixed set of tags to documents. The classifiers are uploaded to the client and used to decide which candidate document belongs to which topic or which candidate document should be associated with which tag.

According to block 150, the fetched information or RSS content is compared with the user profile. By way of example, a relevancy, ranking, and/or score of the content are determined with respect to the user profile.

According to block 160, a personalization engine is used to recommend or re-rank the fetched content (for example, RSS feeds, hyperlinks, information from blogs, web pages, etc.). Then, according to block 170, the re-ranked content is displayed to the user.

In one embodiment, recommended content is presented to users using a locally running web server. The overall system keeps track of which links shown on the personalized local web sites the user has clicked on. The system also utilizes implicit feedback and other machine learning techniques to continuously improve recommendations over time. The number of items to select from each source resembles the following: i) the previous interest in recommendations from this source, ii) the fraction of visited web pages classified as similar to this category or source, and iii) the similarity of the currently available articles to the profile of this category.

In one embodiment, the re-ranked fetched content is displayed on the personalized web page of the user. FIG. 2B shows the personalized web page 200 after adjusting or re-ranking one or more of the modules 220-260.

By way of illustration, the headline news module 225 includes re-ranked new stories. These stories are automatically arranged and displayed according to the relevance to the user profile. A comparison of FIGS. 2A and 2B reveals that some stories are added (Story 9 and Story 12), some stories are deleted (Story 2 and Story 4). Further, the stories are re-arranged in the listing of the module. In other words, the hierarchy or importance of stories is altered to present more relevant stories to the profile of the user. Stories relevant to the particular profile of the user are listed first at the top of the module. For example, in FIG. 2A, Story 3 was ranked third in importance. In FIG. 2B, Story 3 is now ranked first (i.e., being at the top of the list in the module). Story 1 was previously presented first and is now ranked fifth.

FIG. 2B shows various examples in the modules where the specific order of information in the modules is determined by the user profile and not the web portal, web designer, host, or the like. The personalized web page is thus automatically adjusted to display content based on the user profile. Content more relevant to the user is presented, while content less relevant is not presented at all or moved down on the hierarchy of the listing.

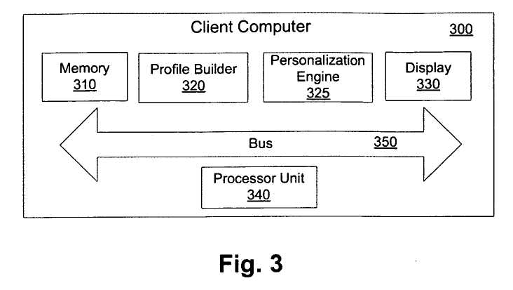

FIG. 3 is a block diagram of a client computer or electronic device 300 in accordance with an exemplary embodiment of the present invention. In one embodiment, the computer or electronic device includes memory 310, profile builder 320, personalization engine 325, display 330, processing unit 340, and one or more buses 350.

In one embodiment, the processor unit includes a processor (such as a central processing unit, CPU, microprocessor, application-specific integrated circuit (ASIC), etc.) for controlling the overall operation of memory 310 (such as random access memory (RAM) for temporary data storage, read only memory (ROM) for permanent data storage, and firmware). The processing unit 340 communicates with memory 310, profile builder 320, and personalization engine 325 via one or more buses 350 and performs operations and tasks necessary to build a user profile and adjust a personalized web page of the user according to the user profile. The memory 310, for example, stores applications, data, programs, algorithms (including software to implement or assist in implementing embodiments in accordance with the present invention) and other data.

Exemplary embodiments provide a system that automatically establishes a personalized content recommendation engine, without requiring end users to provide any kind of configuration. The system can utilize any information found on a local or client computing or electronic device to build a profile. Embodiments include full web usage history of the user. This usage goes beyond click-streams in that the page content itself can be continuously stored and indexed at negligible additional costs. This even holds for content retrieved via secure HTTP. Additional information sources, like local email contacts and emails can also be utilized as required.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

As used herein, the term “webpage” or “web page” means a resource of information that is suitable for the World Wide Web (WWW or web) and can be accessed through a web browser. This information is usually in HTML (Hyper Text Markup Language) or XHTML (Extensible Hyper Text Markup Language) format, and may provide navigation to other web pages via hypertext links. Web pages are a type of electronic or web document and include files of stored text. In one exemplary embodiment, a web page is a document on the World Wide Web (WWW) and identified with a Uniform Resource Locator (URL).

Exemplary embodiments are not limited to web pages, but also include other electronic media and electronic documents. As used herein, an “electronic document” is electronic media content that are intended to be used in electronic form.

As used herein, the term “RSS” means a type of Web feed formats used to publish frequently updated content such as blog entries, news headlines, podcasts, and other information. An RSS document, which is called a “feed,” “web feed,” or “channel,” contains either a summary of content from an associated web site or the full text. With RSS feeds to a web page or electronic documents, users receive current information from their favorite web sites in an automated manner that is easier than manually retrieving such information.

As used herein, the term “relevancy” or “relevant” means having significant and demonstratable bearing on a topic, issue, or matter at hand.

As used herein, the term “client computer” means a personal computer or user workstation that connects to a server to perform a function. Further, as used herein, the term “link” or “hyperlink” means a reference or element in an electronic document that links to another place in the same document or to an entirely different document.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
receiving information on a client computer from a server;
determining at the client computer a relevancy of the information with respect to a user profile;
adjusting a ranking of the information according to the relevancy; and
displaying a selected portion of the information on the client computer, based on the adjusted ranking.

2) The method of claim 1, wherein the information includes information from an RSS feed.

3) The method of claim 1 further comprising, wherein the selected portion of the information is displayed on a personalized web page at the client computer.

4) The method of claim 1 further comprising, rearranging a hierarchical order of the information with respect to the user profile.

5) The method of claim 1 further comprising, arranging RSS feeds in a module on a personalized web page based on the ranking of the information according to the relevancy.

6) The method of claim 1 further comprising:
adding RSS feeds displayed on a personalized web page based on the ranking of the information according to the relevancy;
removing RSS feeds displayed on the personalized web page based on the ranking of the information according to the relevancy; and
re-ranking RSS feeds displayed on the personalized web page based on the ranking of the information according to the relevancy.

7) The method of claim 1 further comprising, listing hyperlinks to stories in a hierarchy based on how relevant the stories are to the user profile.

8) A tangible computer readable medium having instructions for causing a computer to execute a method, comprising:
building a profile of a user on a client computer;
receiving information from an RSS feed on the client computer;
ranking the information with respect to the user profile; and
displaying the information of the user according to the ranking.

9) The computer readable medium of claim 8 further comprising:
prefetching web content that includes web pages, RSS feeds, and information from blogs;
converting the web content in textual documents; and
determining a relevancy between the textual documents and the profile.

10) The computer readable medium of claim 8 further comprising, using web browser plug-ins installed on the client computer to collect information to build the profile.

11) The computer readable medium of claim 8 further comprising, analyzing a web browsing history of the user on the client computer to build the profile.

12) The computer readable medium of claim 8 further comprising, extracting content from web pages visited by the user on the client computer to build the profile.

13) The computer readable medium of claim 8 further comprising:
computing an average TFIDF (term frequency inverse document frequency) vector of documents from web pages visited by the user; and
ranking the documents according to the profile.

14) The computer readable medium of claim 8 further comprising, using time to assign a higher weight to web pages more recently visited by the user.

15) The computer readable medium of claim 8 further comprising, using a timestamp of web pages visited by the user to compute a decay factor that changes scores assigned to the web pages.

16) A computer, comprising:
a memory storing an algorithm; and
processor to execute the algorithm to:
determining at a client computer a relevancy of RSS feeds with respect to a user profile built on the client computer;
ranking the RSS feeds with respect to the relevancy; and
displaying the RSS feeds on an electronic device in accordance with the relevancy.

17) The computer of claim 16, wherein the processor further executes the algorithm to track which hyperlinks a user clicks on to perform adjustments to the user profile.

18) The computer of claim 16, wherein the processor further executes the algorithm to analyze a web browsing history stored on the client computer to build the user profile.

19) The computer of claim 16, wherein the processor further executes the algorithm to continuously store on the client computer content of web pages visited by a user so as to update the user profile.

20) The computer of claim 16, wherein the processor further executes the algorithm to rearrange a hierarchical order of the RSS feeds with respect to the user profile, and the RSS feeds are displayed on a personalized web page on the client computer.
